(19) United States
(12) Patent Application Publication
(10) Pub. No.: US 2009/0154524 A1
(43) Pub. Date: Jun. 18, 2009

(54) Integrated System for Hydro-Thermo-Sanitary Apparatuses

(76) Inventor: Agostino Girelli, Roma (IT)

Correspondence Address: STETINA BRUNDA GARRED & BRUCKER, 75 ENTERPRISE, SUITE 250, ALISO VIEJO, CA, 92656, US

(21) Appl. No.: 12/226,762

(22) PCT Filed: Apr. 27, 2007
(86) PCT No.: PCT/IB2007/001100

§ 371 Date: Oct. 27, 2008

(30) Foreign Application Priority Data
Apr. 28, 2006 (IT) RM2006A000232

(51) Int. Cl. G01K 13/02; A47K 3/28; F24H 3/00; E03D 9/00; F03B 13/10

(52) U.S. Cl. 374/148; 4/597; 237/71; 4/314; 290/54; 374/E13.006

(57) ABSTRACT

An integrated system for hydro-thermo-sanitary apparatuses comprising electric current generating means, a control board, water temperature sensors and LEDs or strips of LEDs arranged near the water outlet section for indicating the dispensed water temperature according to the colour with which the light of the LEDs is emitted. An acoustic-vocal indicator may also be provided.

### FIELD OF THE INVENTION

The present invention relates to an integrated system for hydro-thermo-sanitary apparatuses, such as a dispensing device for hydraulic systems, for example a faucet, a shower head or other similar device.

### STATE OF THE ART

Various types of dispensing devices for hydraulic-sanitary systems are known, such as faucets, shower heads and the like. Over time, these hydraulic components have acquired an increasing importance in the furnishing of the environment, such as for example a bathroom, in which they are installed. This importance has led to an increasing care for the aesthetic design of these components and has boosted the research of new functions aimed at further valorising these objects. In addition to aesthetic furnishing needs, the need to improve visual and hygienic conditions in the water dispensing zone and to provide variable lighting to inform the user about the dispensed water temperature has also been felt.

An example of these dispensing devices is described in document U.S. Pat. No. 6,439,472.Such dispensing device is provided within its housing with a hollow cylindrical part connected to the water feeding conduit and provided with an opening through which elastic ends of an external electrical circuit, arranged within the housing, face within the cylindrical part. By effect of the passage of a water flow, the ends come into contact and close the circuit which comprises one or more batteries, coupled to an electronic board, which power light emitters. Water temperature sensors are provided on one of said ends which send signals to the electronic board which, in turn, controls a variation of lighting from the emitters so as to warn the user when the temperature of water is high.

Disadvantageously this dispensing device, despite having a compact electrical circuit accommodated entirely within, thus preventing an external power supply in humid environment, requires the user intervention to remove the dispenser and replace the batteries, when they are exhausted. Furthermore, an imperfect tightness in proximity of the cylindrical part opening may cause the passage of water into the zone of the dispenser where the batteries and electronic board are accommodated, which may damage the lighting control system. The need for making a multiple integrated system for hydro-thermo-sanitary apparatuses capable of solving the aforesaid drawbacks is therefore felt.

### SUMMARY OF THE INVENTION

The primary object of the present invention is to make a multiple integrated system for hydro-thermo-sanitary apparatuses provided with lighting and/or acoustic vocal means powered by miniaturised energy generators contained within a dispensing device, in its terminal part or in proximity of said part, so as to require no intervention by the end user.

A further object is to provide within the dispensing device, in total safety, an electronic control system capable of adjusting light and/or sound or voice message emission according to the dispensed water temperature.

Therefore the present invention aims at reaching the objects discussed above by means of an integrated system for hydro-thermo-sanitary apparatuses, such as a faucet, a shower head, a shower cabin, a radiator in a heating system, a toilet bowl, arranged along a hydraulic conduit, which, according to claim 1, comprises electric current generating means adapted to be fed by the water flowing in the conduit, light indicating means adapted to be powered by said electric current generating means, electronic control means for controlling the electric current and monitoring the temperature of the water in the conduit, at least one temperature sensor of the water in the conduit connected to said electronic means, wherein the electric current generating means and the electronic control means are incorporated in a single body arranged in the conduit.

Advantageously, the miniaturisation of electrical energy generation/supply systems makes it possible to apply the invention in the space occupied by a simple jet-disturber or in the terminal part of a tap or shower head so as to replace the jet-disturbers or terminal parts existing in previously installed hydraulic systems.

A further advantage is in that the control system according to the present invention may be applied to various sanitary furnishing components, such as for example shower cabins, toilet seats, shower heads, showers, taps, etc., so as to also make aesthetic improvements thanks to particular and various arrangements of a plurality of LEDs on said components.

### BRIEF DESCRIPTION OF THE FIGURES

Further features and advantages of the present invention will be apparent in the light of the detailed description of preferred, but not exclusive, embodiments, of a multiple integrated system for hydro-thermo-sanitary apparatuses illustrated by way of non-limitative example, with reference to the accompanying drawings, in which:

FIG. 1 schematically shows a system according to the invention in a first embodiment;

FIG. 2 is a diagram of control means of the system according to the invention;

FIG. 3 schematically shows a second embodiment of the system according to the invention;

FIG. 4 schematically shows a different embodiment of the system according to the invention;

FIG. 5 shows a sectional view of a shower head comprising the system according to the invention;

FIG. 5a shows a enlarged detail of the view in FIG. 5;

FIG. 6 shows a bottom view of the shower head in FIG. 5;

FIG. 7 shows a sectional view of an embodiment of the shower head in FIG. 5;

FIGS. 8a and FIG. 8b show a sectional view of the system according to the invention arranged in two different points of a hydraulic system, respectively;

FIGS. 9 and 10 show sectional views of two embodiments of a terminal part of another embodiment of the system according to the invention;

FIGS. 11 and 12 show a cross-sectional view of a turbine of the-system according to the invention and a top view of its impeller, respectively;

FIGS. 13 and 14 respectively show. a cross-sectional view and a top view of a further embodiment of said end part;

FIGS. 15, 16, 17 and 18 show further applications of the system according to the invention;

FIG. 19a shows a side view of components of the system reciprocally integrated in a first manner;

FIGS. 19b and 19c respectively show a side view and a cross-sectional front view of the components in FIG. 19a reciprocally integrated in a second manner;

FIG. 20a shows a variant of a component of the system according to the invention;

FIG. 20b shows an application of the component in FIG. 20a;

FIG. 21 shows a further component of the system according to the invention.

### DETAILED DESCRIPTION OF PREFERRED EMBODIMENTS OF THE INVENTION

With reference to the figures it is represented an integrated system for hydro-thermo-sanitary apparatuses according to the invention applied to a dispensing device, indicated as a whole in the various embodiments by reference number 1 and comprising a body 2 of the device in which a water passage 3 leading out through at least one dispensing outlet 5 is defined.

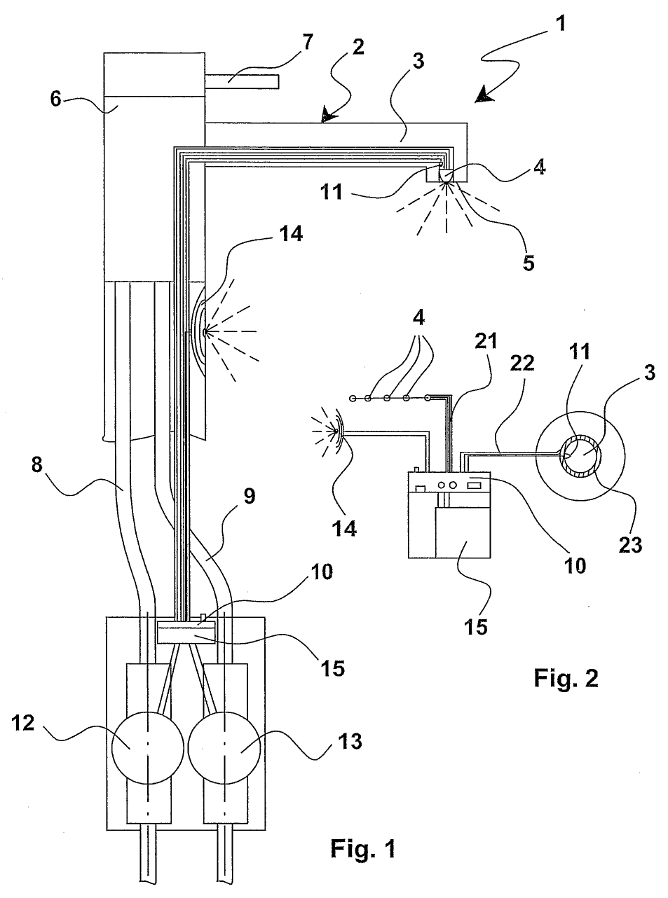

According to the type of device, there are provided only one water feeding conduit or two water feeding conduits 8, 9, one for hot water and one for cold water, which are connected to passage 3 through a mixer or mixing valve 6, controlled by an actuating handgrip 7, as shown in FIG. 1 which refers to a dispensing device consisting of a water faucet. This first embodiment comprises lighting means 4 adapted to emit at least one light beam in proximity of the outlet 5. Said lighting means 4 comprise at least one light source powered by electrical energy by electrical energy generation means which comprise a first turbine 12 or dynamo or water generator arranged along the conduit 8 and a second turbine or dynamo or water generator arranged along the conduit 9. These two miniaturised turbines may preferably but not necessarily be axial. Each of the turbines 12, 13 is moved by the flow of water along the corresponding feeding conduit so that, when the dispenser is open, electrical energy used for feeding the light source(s) of lighting means 4 is generated.

Preferably, the lighting means comprise at least two LEDs adapted to emit light beams of mutually different colours. Optionally, the light sources may be arranged in a single light body, for example of the RGB LED type or similar. The embodiments shown in the figures above-mentioned refer to a solution of this type. The number of LEDs may be higher as required.

The two turbines 12, 13, as shown in FIG. 1, are connected to lighting means 4 by means of an electronic control and monitoring unit 10, which is capable of modulating the feed of electrical energy to the light sources and is also connected to a temperature sensor 11, arranged in the passage 3, to detect the dispensed water temperature. In this first embodiment, sensor 11 is arranged near dispensing outlet 5. Such sensor 11 is connected in input to electronic control unit 10 and; practically, said control unit 10 adjusts the light intensity of the light sources according to the dispensed water temperature controlled by the sensor itself. Adjustment is preferably performed so that the colour of light flux produced by the combination of light fluxes emitted by the light sources corresponds to the dispensed water temperature. In this way, the user may be visually informed on the predominance of hot or cold water in the water dispensed through the dispensing outlet.

Advantageously, the electronic control unit 10 can be set by means of a setting button, according to the temperature detected by sensor 11 and is capable of managing the colours of the GRB LED and possibly an acoustic-vocal indicator 14.

The diagram shown in FIG. 2 shows the control system incorporated in the dispensing device of FIG. 1 where the corresponding elements are indicated with the same numbers. There is provided a flux sensor 23 which closes the circuit at the passage of water in passage 3. Such flux sensor may be, for example, or the capacitive type or provided with ends of an electrical circuit adapted to close by exploiting the electrical conductivity of water in its passage. The flux sensor, or more generally the activation means of the system according to the invention, may also be of the infrared, inductive or piezoelectric type.

As concerns the LEDs 4, blue colour may be chosen, for example, if the temperature T of the dispensed water is lower than or equal to 30° C.; green (or blue plus red) if T is from 30 to 38° C.; red if T is higher than 38° C. As concerns the acoustic-vocal indicator 14; this may emit an acoustic signal if the temperature exceeds a predetermined value, for example 38° C.; and/or may emit a voice message which informs the user on the current temperature of the water being dispensed.

Advantageously, the acoustic-vocal indicator 14 may further perform an alarm function in the case in which the water continues to be dispensed after a predetermined interval of time. Indeed, electronic control unit 10 is programmed so as to transmit an input to indicator 14 which will emit the alarm signals. This contrivance is aimed at avoiding flooding and containing water consumption.

A buffer battery 15 or accumulator may be provided for emergency cases when the turbine or turbines of the device, for example, cannot generate sufficient electric current. Such buffer battery 15 will be charged by the turbines or dynamo which will extend its life span.

This configuration, which provides miniaturised hydraulic turbines for supplying energy to the lighting means by means of the electronic control unit, may be advantageously used in other embodiments of the dispensing device.

Furthermore, in the figures, the position of temperature sensor 11 is only an example; it may indeed be changed according to the assembly type and the space use requirements of the dispensing device.

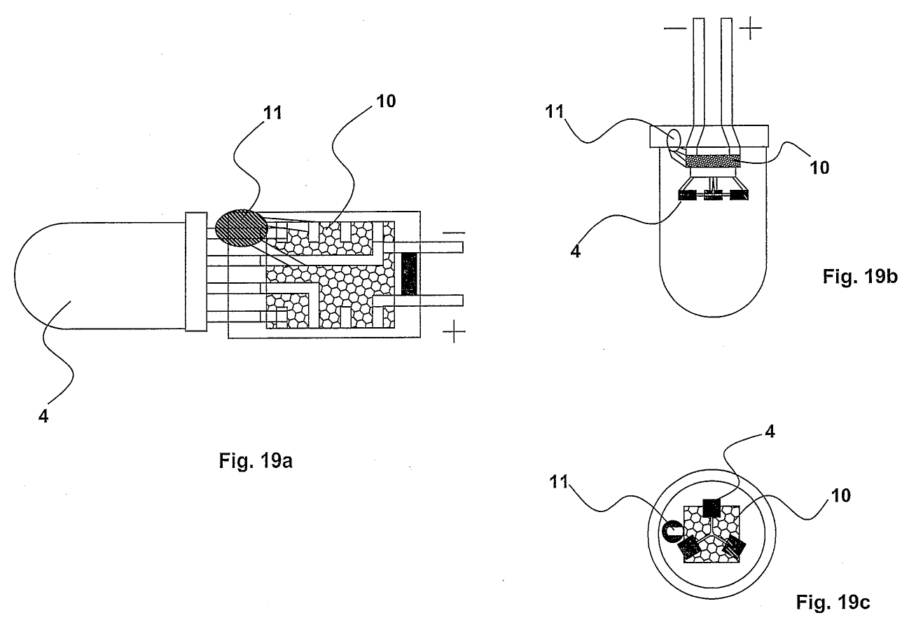

Advantageously, electronic control board 10 and/or temperature sensor 11 may be integrated with LED 4 itself, thus obtaining a further miniaturisation of the system, as shown, for example, in FIGS. 19a, 19b, 19c.

Specifically, in the alternative embodiment of FIG. 19a, electronic control board 10, in the form of a microchip, and temperature sensor 11 are integrated with LED 4 but arranged externally thereto.

In the alternative embodiment of FIG. 19c, instead, electronic control board 10, in the form of a microchip, and temperature sensor 11 are integrated within LED 4. These three integrated components, in both said alternative embodiments, are then inserted in a protective capsule and positioned along the hydraulic conduit.

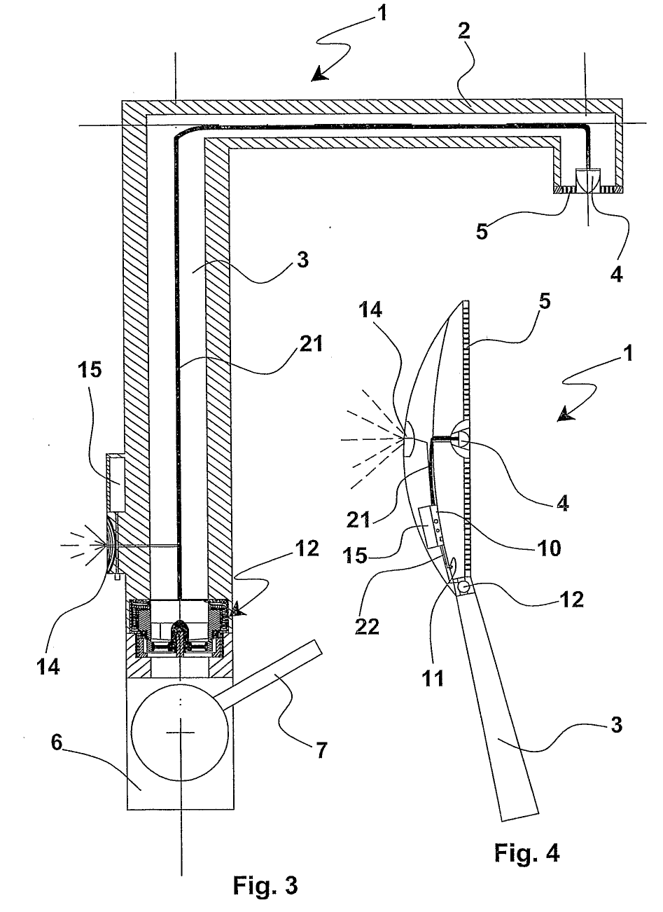

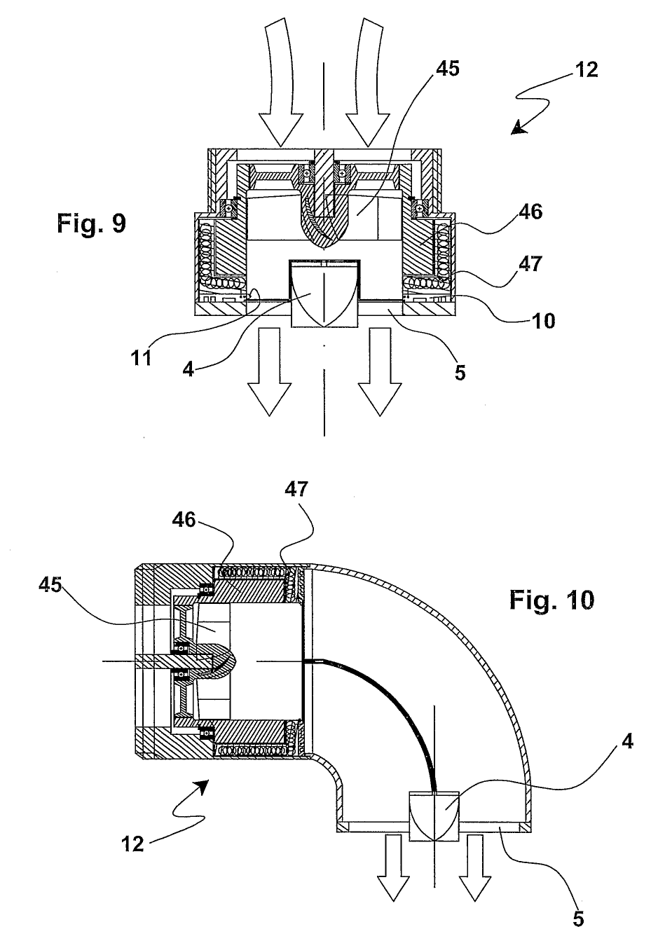

A second embodiment of the integrated system according to the invention is shown in FIG. 3, where the component elements corresponding to those of the previous embodiment are indicated by the same numbers. In this embodiment, the part incorporating at least one turbine 12 and the miniaturised control system, comprising the control unit 10 and the temperature sensor 11, is arranged downstream of the mixer 6. There are provided a buffer battery 15 and the acoustic-vocal device 14, arranged on the external surface of body 2. Turbine 12 in FIG. 3 is better shown in the magnified view of FIG. 9.

This second embodiment allows the further advantage of being able to replace, in case of need, only the part downstream of the mixer 6, i.e. to replace the dispensing pipe of the faucet itself, which is further adaptable to previously installed faucets as it is provided with a universal type connection.

Also in this case the electronic control board and/or the temperature sensor may be integrated within LED 4 itself thus obtaining a further miniaturisation of the system.

A further embodiment, shown in FIG. 4, provides that the system according to the invention is applied to a shower provided with luminous LEDs 4 indicating the water temperature and controlled in the same way as in the previous embodiments.

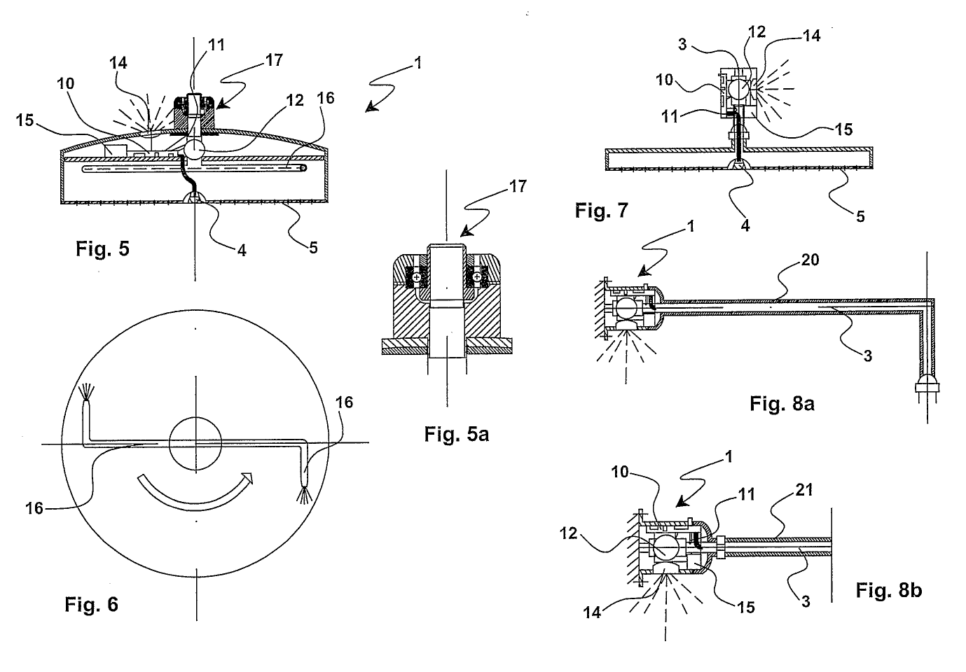

FIGS. 5 and 6 instead show a shower head which comprises the system according to the invention and in which there is provided a system of radial and tangential accelerating conduits 16 which let the shower head rotate thanks to the thrust generated by the motion quantity of the water deviated by the particular shape of the conduits 16 themselves. The shower head rotation system comprises, in addition to said conduits 16, a bearing system 17, for example as that one shown in FIG. 5a, arranged on inlet passage 3 of the water in the shower head.

In the embodiment of the shower head shown in FIG. 7, the integrated electricity generation and control system is instead arranged externally to the shower head itself. In this case the shower head is provided with a further mechanism which allows it to rotate about its axis exploiting the energy of the water. In the further embodiments shown in FIGS. 8a and 8b, the electricity generation and control system is positioned respectively inside a supporting arm 20 of a shower head and in proximity of a water intake of the tube 21 of a shower.

In figures from 4 to 8b, the component elements of the system according to the invention, corresponding to those of the embodiment in FIG. 1 described above, are indicated by the same reference numerals.

The embodiment of the dispenser, two variants of which are shown in FIGS. 9 and 10, shows the electricity generation system and the control system of a device according to the invention arranged on the terminal part of a faucet. The miniaturisation of electrical energy generation/supply systems makes it advantageously possible to apply the invention in a space normally occupied by a simple jet-disturber or in the terminal part of a faucet or shower head so as either to replace the jet-disturber or terminal parts existing in previously installed hydraulic systems or to add them without revolutionising the overall dimensions of the faucet.

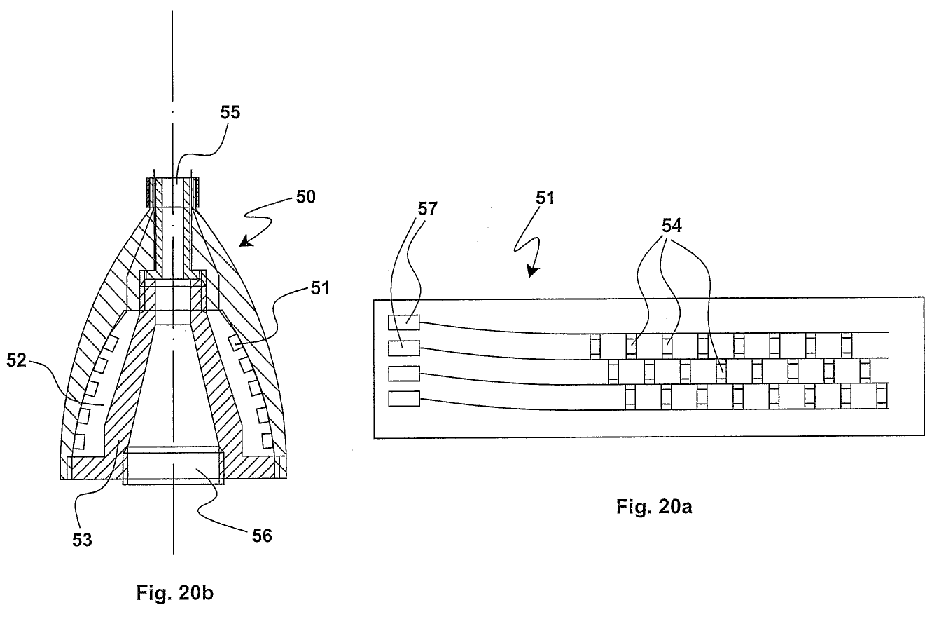

In the alternative embodiment, shown in FIG. 20b, it is provided the use, e.g. within. a shower dispenser. 50, of lighting means 4 comprising at least one flexible membrane 51 (FIG. 20a) provided with strips of multicolour LEDs 54 and corresponding contacts 57. Such membrane 51 is housed within a cavity 52 of the dispenser 50 and the generated light is diffused through an internal body 53 formed by transparent material, such as for example ABS, polycarbonate or the like. The water comes from terminal conduit 55 of the shower hose, flows through the internal body 53 and exits through jet-disturber or aerator 56.

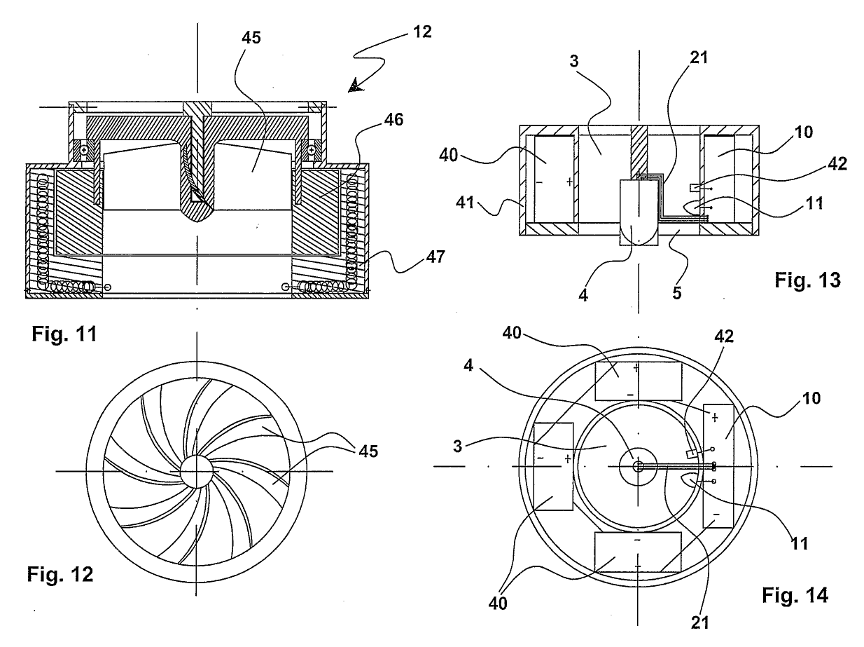

In the different embodiments of the invention, the used turbine or turbines 12 are preferably, but not necessarily, of the axial type with blades 45, for example helical shaped, which put into rotation a rotor 46, which is a permanent magnet, with respect to a stator 47 generating an electric current in the known way. Variants of the turbine are shown in FIGS. 9, 10 and 11.

A further embodiment of the dispenser, with the integrated electricity generation and electronic control system arranged in its terminal part, is shown in FIGS. 13 and 14. This embodiment provides the use of batteries 40, for example in number of three, arranged between the water passage 3 and the case 41 of the jet disturber or terminal part. For activating the batteries 40, there is provided an operating system 42 which provides, for example, a capacitive sensor or pressure switch or flow switch or two ends of an electrical circuit adapted to close exploiting the electrical conductivity of water in its passage.

Lighting means 4 are preferably arranged so as to emit the light beam according to the water dispensing direction through dispensing outlet 5 and, according to needs, such light beam may be essentially parallel to the water dispensing direction or may be oriented according to a direction which is incident to the dispensed jet of water or may be emitted within the jet itself.

In a first variant, not shown, the lighting means 4 comprise at least one light source, which may comprise a lamp or a LED, applied outside the body of the dispenser device in proximity of the dispensing outlet, and oriented so as to emit a light beam according to a direction essentially parallel or incident to the direction of the dispensed water jet.

In a second variant, said at least one light source is arranged within the dispensing device body in proximity of the dispensing outlet. Preferably, the light source is placed in the middle of said outlet. This case is shown, for example, in FIGS. 1, 3, 4, 9, 10, 13.

In a third variant, not shown, said at least one light source is arranged in a remote zone with respect to the dispensing outlet. The light emitted by the light source is transmitted to a zone near the dispensing outlet through light transmitting means, for example at least one optical fibre which presents one initial end facing the light source and the opposite or final end facing the dispensing outlet. Preferably, the optical fibre develops at least partially within the dispenser body, and more preferably at least in its final segment, coaxially to the dispensing outlet terminating in correspondence of said outlet. In these variants, electrical wires 21 feeding the light sources or optical fibre, as well as electrical wires 22 connecting the temperature sensor 11 to the electronic control unit 10, visible in the diagram in FIG. 2, may be accommodated in a tube arranged within. passage 3 of the dispensing device body 2 which is already available, although for other purposes, in some types of marketed faucets.

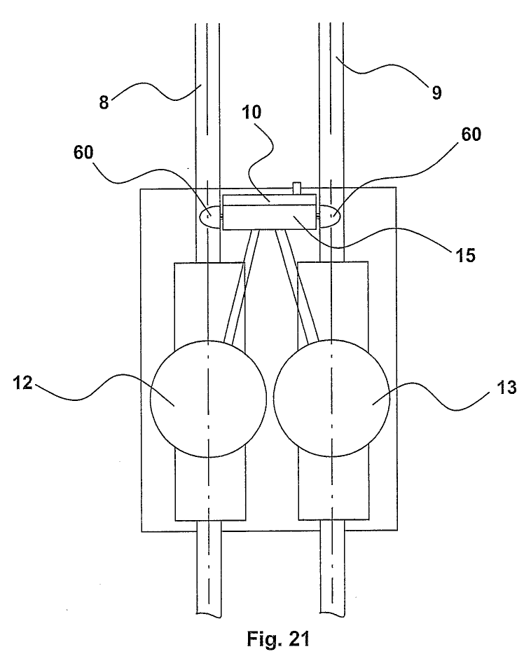

Conveniently, it is also possible to provide one or more UVC lamps or LEDs 60 adapted to emit UVC ray, in addition or alternatively to the light sources above, such as LEDs. Such UVC lamps are arranged so as to emit a UVC ray beam within an appropriately dimensioned zone, thus obtaining a sanitising effect on the water flow. Such UVC lamps may be powered autonomously or by means of at least one electric current generator, such as one or more turbines 12, with or without buffer batteries 15. FIG. 21 shows a variant of the embodiment in FIG. 1 with two UV lamps 60 arranged near electronic control unit 10.

All dispenser embodiments described above may be equipped with batteries or accumulators to allow the turn-on of lighting means 4 and/or the activation of the acoustic-vocal indicator 14 also when the energy generated by the turbines is not sufficient.

The electrical supply means may also provide an emergency system powered by the electric network to which the lighting and/or acoustic-vocal indicating means are connected via a transformer so as to power said sources at low voltage. Advantageously, if the supply means consists of the electric network or batteries or accumulators, along the electrical supply circuit a switch is arranged to control the operation of the acoustic-light sources. Such a switch may be comprised of a switch integrated or connected to the opening-closing handgrip of the dispensing device. The switch may also be of the automatic type providing, for example, a pressure sensor arranged along the water feeding conduit or two pressure sensors arranged along the two water feeding conduits which is or are affected by the variations of pressure along said conduit or conduits and which operate the switch to close the electrical circuit when water is dispensed through the dispensing outlet. Alternatively, the acoustic-light source activation system may be of the photocell type or of the capacitive or inductive or piezoelectric type. Advantageously, the system of generation and modulated supply of energy to the lighting and/or acoustic-vocal indicating means, by means of the electronic control unit and temperature sensor connected to it, provided in the device according to the invention may be applied to various bathroom components.

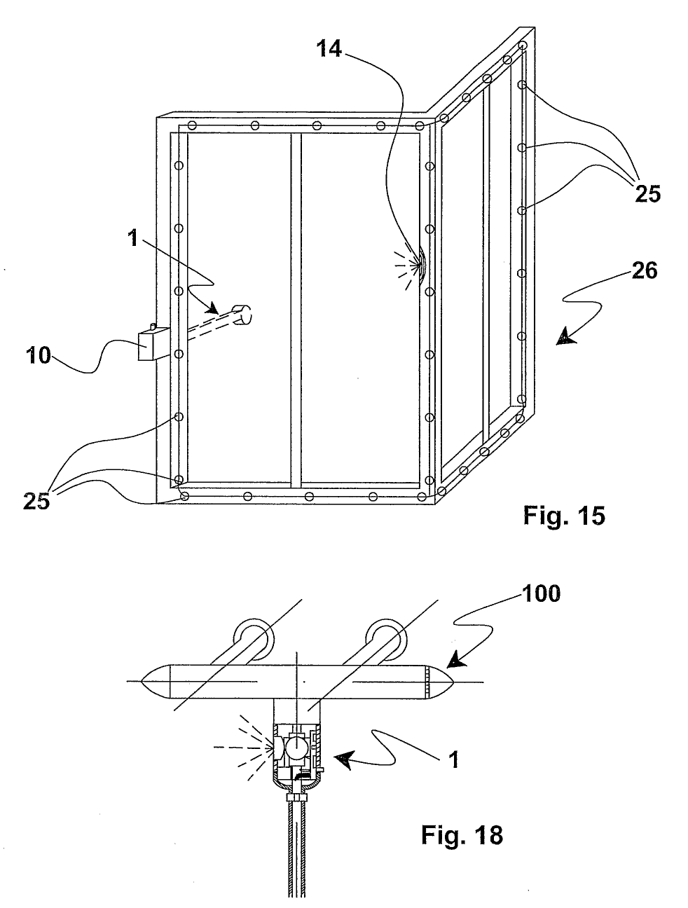

For example, the integrated system according to the invention may be used as a stretch of a water feeding tube in a shower and the generated electric current is used to switch on LEDs 25 appropriately arranged in the shower cabin 26 to indicate by means of light signals, inside or outside the cabin 26, the water temperature. Such embodiment is shown in FIG. 15. An acoustic-vocal indicator 14 may be provided, arranged on the cabin 26. Thanks to a flow sensor, which closes the system when there is passage of water, and a temperature sensor, both positioned for example in proximity of the water outlet section, the electronic control unit 10 modulates the brightness and/or the colour of the LEDs 25 and operates the indicator 14.

FIG. 16 shows instead the use of the integrated system according to the invention which generates electric current for switching on LEDs 27 appropriately arranged on a radiating body or towel warmer 28 of a heating system for indicating. the temperature of the radiating body. In this case, device 1 is arranged along the hot water delivery conduit.

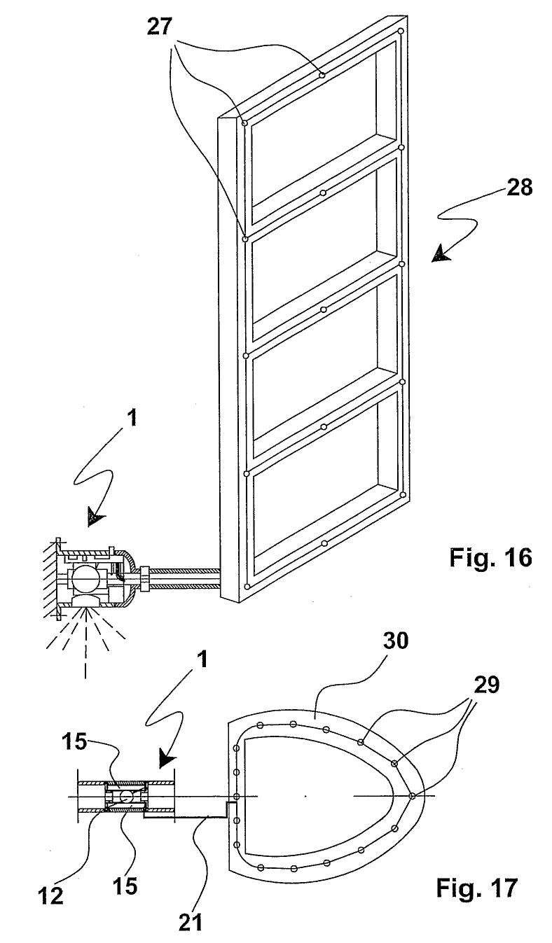

FIG. 17 shows an application of integrated system according to the invention for switching on, in controlled way, a plurality of LEDs or a strip of LEDs 29 arranged on a toilet seat 30. In proximity of the water outlet is arranged in the water passage a turbine 12 adapted to supply the batteries 15 and the strip of LEDs 29. Alternatively, the system may be activated by the piezoelectric sensors.

Finally, FIG. 18 shows a further application of the integrated system of the invention on a thermostatic tap 100, i.e. on a tap which allows to rapidly obtain the required temperature and maintain it constant in time.

In all the described embodiments of the system and in the various applications, the electronic control board and/or the temperature sensor may be integrated within the lighting means thus obtaining a further miniaturisation of the system itself.

1. An integrated system for hydro-thermo-sanitary apparatuses, such as a faucet, a shower head, a shower cabin, a radiator in a heating system, a toilet bowl, arranged along a hydraulic conduit, comprising electric current generating means (12, 13) adapted to be fed by the water flowing in the conduit, light indicating means (4, 25, 27, 29, 54) adapted to be powered by said electric current generating means, electronic control means (10) for controlling the electric current and monitoring the temperature of the water in the conduit, at least one temperature sensor (11) of the water in the conduit connected to said electronic means (10), wherein the electric current generating means and the electronic control means are incorporated in a single body arranged in the conduit.

2. A system according to claim 1 wherein the electric current generating means are water turbines.

3. A system according to claim 1 wherein said body is arranged upstream of a water mixer valve (6).

4. A system according to claim 1 wherein said body is arranged downstream of a water mixer valve (6).

5. A system according to claim 1 wherein said body is arranged in proximity of a water dispensing outlet section (5).

6. A system according to claim 1, comprising electric current accumulators (15, 40).

7. A system according to claim 1, wherein there is provided an acoustic indicator (14) adapted to indicate the water temperature, said indicator being controlled by the electronic control means (10).

8. A system according to claim 1, wherein said at least one temperature sensor (11) is arranged within said body.

9. A system according to claim 1, wherein said at least one temperature sensor (11) is arranged outside said body.

10. A system according to claim 1, wherein said electronic control means (10) and said at least one temperature sensor (11) are integrated within light indicating means (4).

11. A system according to claim 1, wherein the light indicating means comprise at least one LED (4).

12. A system according to claim 11, wherein said light indicating means comprise a plurality of LEDs (25, 27, 29, 54).

13. A system according to claim 12, in which said plurality of LEDs (54) is provided on a flexible membrane (51).

14. A shower cabin comprising an integrated system (1) according to claim 1.

15. A radiator in a heating system comprising an integrated system (1) according to claim 1, arranged along a water delivery conduit in said radiator.

16. A toilet bowl comprising in proximity of an outlet conduit of the water into said bowl an integrated system (1) according to claim 1.
